(19) United States
(12) Patent Application Publication
(10) Pub. No.: US 2006/0051629 A1
(43) Pub. Date: Mar. 9, 2006

(54) Fuel cell system and shutdown method for a fuel cell system

(76) Inventors: Uwe M. Limbeck, Kirchheim/Teck (DE); Holger Richter, Kirchheim/Teck (DE)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/190,491

(22) Filed: Jul. 26, 2005

Related U.S. Application Data
(60) Provisional application No. 60/654,393, filed on Feb. 18, 2005.

(30) Foreign Application Priority Data
Sep. 3, 2004 (DE) 10 2004 042 806.9

(51) Int. Cl. H01M 8/00; H01M 8/04

(52) U.S. Cl. 429/13; 429/33; 429/40; 429/17

(57) ABSTRACT

A fuel cell system having at least one fuel cell, which possesses one anode area as well as one cathode area that is separated from the anode area by an electrolyte. The anode area and the cathode area each contain one catalyst for the catalytic conversion of reactants being supplied to the fuel cell. During downtime periods of the fuel cell, the anode area is filled with air or oxygen. Provided in the area of an inlet and/or in the area of an outlet of the anode area is an additional catalyst for the catalytic conversion of hydrogen with oxygen, which is set up to catalytically convert hydrogen diffusing towards the anode area during downtime periods of the fuel cell when the anode area is filled with air or oxygen.

### CROSS-REFERENCES TO RELATED APPLICATIONS

This application claims the benefit under 35 U.S.C. § 119(e) of U.S. Provisional Patent Application No. 60/654,393 filed Feb. 18, 2005, and also claims priority to German Application No. 10 2004 042 806.9 filed Sep. 3, 2004; both of these applications are incorporated herein by reference in their entireties.

### BACKGROUND OF THE INVENTION

1. Field of the Invention

The invention generally pertains to a fuel cell system as well as to a method to shut down a fuel cell system.

2. Description of the Related Art

Typical fuel cells in use today comprise one cathode area as well as one anode area, which is separated from the cathode area by an electrolyte. Different electrolytes are used for different types of fuel cells. For example, the electrolyte of a polymer-electrolyte-membrane fuel cell is a proton-conducting membrane. During operation of the fuel cell, the anode side is supplied with hydrogen while the cathode side is supplied with an oxygen-containing oxidant, for example air. At the anode catalyst present in the anode area, the hydrogen molecules react according to the chemical equation
H₂→2·H⁺+2·e⁻
forming positively charged hydrogen ions while releasing/loosing electrons to the electrode.

The H⁺ ions formed in the anode area subsequently diffuse through the electrolyte to the cathode, where at a cathode catalyst, which is located in the cathode area and typically has been applied onto a carbon support, they react together with the oxygen supplied to the cathode and with the electrons conducted to the cathode via an external circuit according to the equation
0.5·O₂+2·H⁺+2·e⁻→H₂O
to form water.

It is known in the prior art, e.g., from US 2003/0134164 A1, that under certain operating conditions the carbon carrier material of the cathode catalyst can be subject to strong corrosion. This is the case whenever the cathode area of the fuel cell is full of air and at the same time certain sections of the anode area are full of air while other sections are full of hydrogen-containing gas.

During normal operation of the fuel cell, the anode area is continuously supplied with hydrogen, which results in an essentially uniform distribution of hydrogen throughout the anode area. But problems with respect to the above-described inhomogeneity of the gas composition in the anode area of the fuel cell can arise during the phase after shutdown and during the start-up phase of the system.

During the shutting-down phase of the fuel cell, the hydrogen supply to the anode and the air supply to the cathode are interrupted. At this point in time the cathode area is full of air and the anode area is full of residual hydrogen. As a result of diffusion of the reactants through the electrolyte, the remaining hydrogen in the anode area is converted with oxygen from the cathode area, forming water in the process. This leads to a drop in pressure in the anode area to below ambient pressure, and as a result ambient air is sucked into the anode area, for example from lines connected to the anode area. In this manner, inlet sections and outlet sections that are accessible to the ambient air are filled with ambient air, while for example sections that are located further inside the anode area still contain residual hydrogen. A homogeneous composition is not established again until the entire quantity of residual hydrogen that remained in the anode area after the shutdown of the fuel cell has been converted and the anode area has been completely filled with air.

Inhomogeneities in the gas composition in the anode area of the fuel cell can arise in a similar manner during the start-up phase of a fuel cell system. For example, if—during the start-up of the fuel cell—hydrogen is supplied via an inlet to an anode area that was full of air during the rest period, this inevitably gives rise to a non-uniform gas composition—if an inlet section of the anode area has already been filled with hydrogen while an outlet section of the anode area still contains air—until the anode area has been completely filled with hydrogen.

The short-circuiting—caused by the inhomogeneous gas composition in the anode area—between the sections of the anode area containing air and the ones containing residual hydrogen gives rise to a diffusion of H⁺ ions through the electrolyte, both along the plane formed by the electrolyte layer and perpendicular to that. Simultaneously, electrons flow on both the anode side and the cathode side of the fuel cell system through the conducting catalyst layers that adjoin the electrolyte. While the flow of electrons gives rise to only a relatively small potential difference in the electron conductor, the comparatively low proton conductivity of the electrolyte in the plane defined by the electrolyte layer leads to a significant difference in electrolyte potential between the sections of the anode area that contain air and the ones that contain residual hydrogen.

On the cathode side of the fuel cell, the reduced electrolyte potential in the sections of the anode area that contain air results in a drastic increase of the electrolyte potential in the corresponding sections of the cathode area. This higher electrolyte potential gives rise to corrosion of the carbon carrier material of the cathode catalyst, i.e., the carbon carrier is oxidized by the oxygen present in the cathode area of the fuel cell and CO₂ is formed in the process. Not only does this corrosion of the catalyst carrier lead to undesirable CO₂ emissions, but it also results in a significant reduction in power of the fuel cell during operation. Moreover, the life expectancy of the fuel cell is noticeably reduced.

At the time of the start-up of the fuel cell system, the time period during which the anode area of the fuel cell contains sections already filled with water at the same time as sections that are still filled with air is dependent on the time it takes to fill the anode area with hydrogen. Consequently, this time span, and at the same time the corrosion of the catalyst carrier located in the cathode area of the fuel cell, can be limited in a comparatively simple manner by feeding the hydrogen into the anode area of the fuel cell at a rapid rate.

For example, US 2002/0076582 A1 and US 2003/0134165 A1 disclose that the corrosion of a cathode-catalyst carrier during the start-up phase of a fuel cell system can be minimized, if hydrogen is supplied to an air-filled anode area of the fuel cell with a flow rate high enough to displace the air from the anode area in less than one second.

As an alternative, US 2003/0129462 A1 suggests that only a limited hydrogen quantity be initially supplied to an air-filled anode area of the fuel cell during the start-up phase of the fuel cell, and that then the hydrogen/air mixture be conducted to burners located in an anode loop for as long as it takes to consume all of the oxygen contained in the gas mixture.

Since the time period during which corrosion of the cathode catalyst carrier—caused by different gas compositions in the anode area of the fuel cell—can arise is relatively short during a start-up of the fuel cell—at least if the hydrogen is supplied to the anode area with a sufficiently high flow rate—one can assume that this corrosion of the catalyst carrier material for the most part is caused by the operating conditions arising after the shutdown of the fuel cell system.

The prior art contains discussions of various approaches to influence these operating conditions with the goal of minimizing the corrosion of the cathode catalyst carrier. For example, US 2003/0134164 A1 suggests that in a shutdown of a fuel cell system one at first interrupt an electrical connection between the fuel cell and a main load as well as interrupt the hydrogen supply to the cathode. Subsequently, an auxiliary load is connected to the cell so that any hydrogen remaining in the anode area of the fuel cell will be used up in the electrochemical cell reactions that also takes place during normal operation. Finally one purges the anode area of the fuel cell with air.

In contrast, U.S. Pat. No. 6,514,635 describes a method in which—after the fuel cell has been disconnected from a main load and the hydrogen supply to the anode has been interrupted—the anode exhaust gases are recirculated in an anode loop, if necessary with added air. This recirculation operation is maintained until the residual hydrogen contained in the anode exhaust gases has been converted in the anode reaction at the anode catalyst, which also takes place during normal operation of the fuel cell, with air oxygen that either diffuses through the electrolyte from the cathode side or is added in a controlled manner into the anode loop. As an alternative to this, the hydrogen/air mixture circulating in the anode loop can also be supplied to a catalytic burner arranged in the anode loop to undergo reaction. After the residual hydrogen has been eliminated from the anode exhaust gases, the cathode area and the anode area are purged with air.

Common to all these procedures is the approach of preventing the above-described conditions immediately after the shutdown of the fuel cell system from being established by eliminating residual hydrogen from the anode area of the fuel cell or the anode loop as completely as possible. But surprisingly it has been found that the corrosion of the carbon support material of the cathode catalyst cannot be prevented to a satisfactory degree despite the measures described in the prior art.

### BRIEF SUMMARY OF THE INVENTION

It is the objective of the invention to present a fuel cell system for which corrosion of the cathode catalyst carrier is minimized.

The invention is based on the surprising finding that after the conversion of all hydrogen remaining in the anode area after the shutdown of the system, i.e., at a time when the anode area is already completely filled with air, there are still traces of residual hydrogen present in components connected to the anode area, such as for example lines, metering valves, etc. Even a purge with air of the anode area or the anode loop cannot entirely eliminate these traces of residual hydrogen.

During the downtime of the fuel cell system, these hydrogen molecules—remaining for example in a line connected with the anode area—diffuse in the direction towards the anode area. This enriches the gas composition in the inlet sections and outlet sections of the anode area with hydrogen, while sections of the anode area located in the interior of the anode area contain exclusively air, i.e., again one deals with operating conditions that lead to the corrosion of the carbon carrier material of the cathode catalyst.

Consequently, as a solution to the above-mentioned problem, the present invention proposes in a fuel cell system with at least one fuel cell, which comprises one anode area as well as one cathode area that is separated from the anode area by a catalyst, whereby each of the anode area and the cathode area contain one catalyst for the catalytic conversion of reactants supplied to the fuel cell, and whereby during downtimes of the fuel cell the anode area of the fuel cell contains air or oxygen, to provide an additional catalyst in the region of an inlet and/or in the region of an outlet of the anode area. This catalyst is designed to catalytically convert any hydrogen diffusing in the direction towards the anode area during the downtime of the fuel cell while the anode area contains air or oxygen.

The arrangement according to the invention makes it possible to convert any hydrogen, which during the downtime of the fuel cell system diffuses towards the anode area that contains air or oxygen, at the additional catalyst, even before it enters the anode area, with oxygen, forming water in the process. In this manner it becomes possible with little additional complexity to prevent any inhomogeneities in the gas composition from forming in the anode area and to prevent the resulting corrosion of the cathode catalyst carrier. In the fuel cell system according to the invention, it is not necessarily required to equip the system with the corresponding equipment for purging the anode area with for example air. In this case, the fuel cell system possesses a particularly uncomplicated design.

In one version of the invention, an additional catalyst for the catalytic conversion of hydrogen with oxygen is provided only in the region of the inlet or only in the region of the outlet of the anode area. An arrangement of this type that possesses a simple design and is easily implemented can for example be practical if on the basis of the design of the fuel cell system one can assume that residual hydrogen will be present after the shutdown of the fuel cell system essentially only in components that have a fluid-conducting connection with the inlet or the outlet.

But as an alternative to this, it is also possible to provide one additional catalyst for the catalytic conversion of hydrogen with oxygen in both the region of the inlet and in the region of the outlet of the anode area, so that during the downtime of the system the anode area of the fuel cell will be protected especially well against hydrogen diffusing towards the inlet and the outlet. Such a configuration of the system according to the invention is particularly advantageous if both the inlet side as well as the outlet side of the anode area contain components that still contain residual hydrogen after a shutdown of the fuel cell system, and/or if the anode area of the fuel cell is connected to a recirculation line for the recirculation of anode gases.

The additional catalyst in the anode area may be arranged exclusively immediately at the inlet and/or exclusively immediately at the outlet of the anode area. Such a comparatively small-volume catalytic area can be realized simply and thus cost-effectively. But as an alternative it is possible to arrange the additional catalyst in a section of a fluid feed line adjoining the inlet of the anode area and/or in a section of a fluid discharge line adjoining the outlet of the anode area. In both these cases, installation of the additional catalyst requires only little additional effort during fabrication and assembly. Furthermore, the additional catalyst can be integrated into already existing components of the system in a space-saving manner. As a result, the fuel cell system according to the invention does not require any additional mounting space, which is a particular advantage if the system is used for mobile applications, for example in fuel cell vehicles.

The additional catalyst preferably is a platinum catalyst. Platinum catalysts are particularly well suited for the catalytic conversion of hydrogen with oxygen. But it is also possible to use other catalyst materials instead of platinum, for example a different noble metal or a noble metal alloy.

In one embodiment of the fuel cell system according to the invention, the additional catalyst is placed in the region of the inlet and/or the outlet of the anode area in the form of a catalytic coating. For example, an inlet section and/or outlet section of the anode area or an interior surface of a fluid supply line connected to the inlet and/or of a fluid discharge line connected to the outlet can be equipped with a catalytic coating of this type.

Alternatively, the additional catalyst may be applied in the form of a coating onto a carrier, whereby the catalyst carrier can be developed as a mesh, non-woven fabric, or monolithically. Particularly in cases where the catalyst carrier possesses a large surface area, it becomes possible to ensure good coverage of the catalyst material in the region of the inlet and/or the outlet of the anode area and thus to guarantee an essentially complete conversion of the hydrogen diffusing into this area/these areas.

As a matter of principle one should ensure that the thermal mass of a design that is equipped with a catalyst coating is as small as possible in order to enable a quick start of the catalytic reaction at the catalyst. In this, it has to be taken into account that the above-described diffusion of residual hydrogen in the direction towards the anode area can continue for up to two hours after the shutdown of the fuel cell system. If necessary, it is also possible to electrically heat the catalyst.

As mentioned before, the fuel cell system according to the invention does not necessarily have to include a system to purge the anode area. But in a preferred embodiment of the invention the fuel cell system comprises means to purge the anode area with air. These means can for example comprise a fan or a pump, suitable fluid lines, as well as valves to control the fluid flow. A purge of the anode area using air after the shutdown of the fuel cell system can significantly shorten the time period during which inhomogeneities in the gas composition occur in the anode area and can consequently reduce corrosion of the cathode catalyst carrier. This is especially possible in cases where the purge-air is supplied to the anode area at a sufficiently high flow rate, so that the anode area will be filled with air within a very short time of for example one second.

In a typical embodiment, the fuel cell system comprises an anode loop with an anode-gas recirculation line. In this case, the means for purging the anode area with air preferably are set to purge with air all of the components of the anode loop that have a fluid-connection with the fuel cell, such as for example fluid lines, valves, etc. This can significantly reduce the amount of hydrogen remaining in these components after shutdown of the fuel cell system.

In the method according to the invention to shut down a fuel cell system with at least one fuel cell, which comprises one anode area as well as one cathode area separated from the anode area by an electrolyte, whereby the anode area and the cathode area each contain one catalyst for the catalytic conversion of reactants supplied to the fuel cell, one initially disconnects an electrical connection between the fuel cell and a load and interrupts the hydrogen supply into the anode area of the fuel cell. Subsequently, the anode area of the fuel cell is filled with air or oxygen. Filling the anode area with for example air can take place by way of the above-described conversion of hydrogen, which remained in the anode area after the hydrogen supply was interrupted, and the subsequent ingress of ambient air into the anode area. Alternatively, active filling of the anode area is also possible, for example by supplying air or oxygen. Any hydrogen that during a downtime of the fuel cell diffuses in the direction towards the air-filled or oxygen-filled anode area is catalytically converted at an additional catalyst arranged in the region of an inlet and/or in the region of an outlet of the anode area.

After the electrical connection between the fuel cell and the load has been disconnected and after the hydrogen supply has been interrupted, the anode area of the fuel cell preferably is purged with air. This can significantly shorten the time period during which inhomogeneities in the gas composition occur in the anode area and thus reduces corrosion of the cathode catalyst carrier. The purge air preferably is supplied to the anode area at a high flow rate, so that the anode area will be filled with air within a very short time period of approximately one second.

In a specific embodiment of the invention's method for shutting down a fuel cell system, all components of an anode loop that have a fluid-conducting connection to the anode area of the fuel cell are purged with air after the interruption of the electrical connection between the fuel cell and the load and after the interruption of the supply of hydrogen into the anode area. This makes it possible to significantly reduce the quantity of hydrogen remaining in these components after the interruption of the electrical connection between the fuel cell and the load and after the interruption of the supply of hydrogen into the anode area.

In the following, a representative embodiment of the invention is explained in more detail with the help of the enclosed drawings.

### BRIEF DESCRIPTION OF THE DRAWINGS

FIG. 1 shows a schematic layout of the relevant section of a fuel cell system according to the invention, and

FIG. 2 shows a larger-scale representation of the fuel cell system according to the invention shown in FIG. 1.

### DETAILED DESCRIPTION OF THE INVENTION

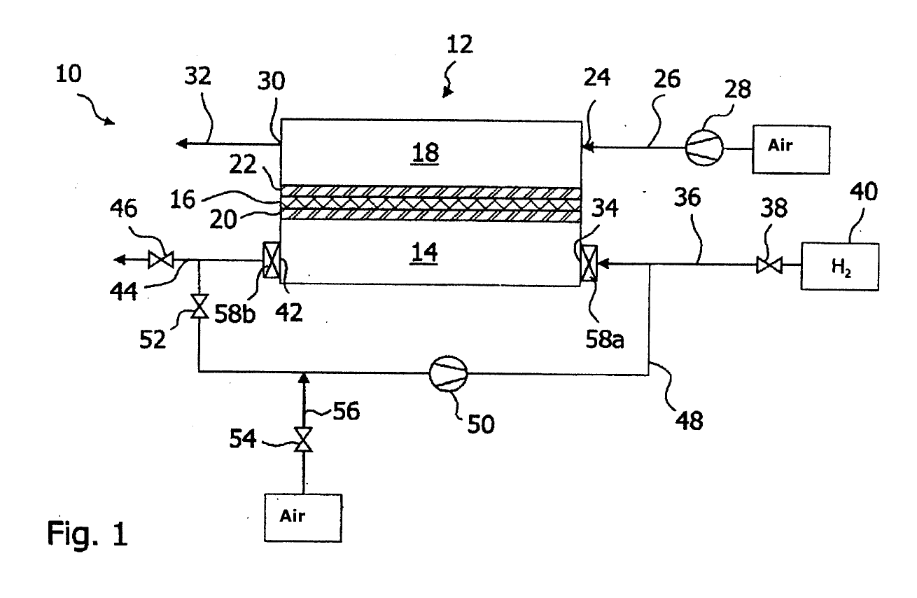

FIG. 1 shows a fuel cell system, labelled 10 in its entirety, comprising one fuel cell 12, which contains one anode area 14, as well as one cathode area 18 that is separated from the anode area 14 by an electrolyte 16. The electrolyte 16 is developed in the form of a proton-conducting polymer film. The anode area 14 and the cathode area 18 each contain a catalyst 20, 22, which have been applied onto a carbon carrier (not shown in detail), for the catalytic conversion of reactants supplied to the fuel cell 12. Even though only a single fuel cell 12 is shown in FIG. 1, the fuel cell system 10 comprises a larger number of fuel cells 12, which are stacked on top of each other to form a so-called fuel cell stack.

The inlet 24 of the cathode area 18 is connected to the ambient air via a cathode gas supply line 26, which contains a pump 28. An outlet 30 of the cathode area 18 opens into a cathode gas discharge line 32.

An inlet 34 of the anode area 14 is connected to a hydrogen source 40 via an anode gas supply line 36, which contains a first valve 38. An outlet 42 of the anode area 14 opens into an anode gas discharge line 44, which contains a second valve 46. A recirculation line 48 branches off from the anode gas discharge line 44 at a point upstream of the second valve 46. Anode exhaust gases issuing from the outlet 42 of the anode area 14 can be recirculated via this recirculation line 48 by means of an additional pump 50 arranged in the recirculation line 48 and can be returned to the anode gas supply line 36. A third valve 52 is located in the recirculation line 48, upstream of the additional pump 50. A purge-air line 56—connectable to ambient air via a fourth valve 54—branches off from the recirculation line 48 between the third valve 52 and the additional pump 50.

In an embodiment of the fuel cell system not shown in FIG. 1, the purge-air line that forms a connection to ambient air branches off from the cathode gas supply line—between a compressor and the fuel cell—and joins the recirculation line downstream of a recirculation fan.

The region of the inlet 34 and the region of the outlet 42 of the anode area 14 each contain one additional catalyst 58a, 58b.

During operation of the fuel cell system 10, the cathode area 14 is supplied with ambient air by the pump 28. The first valve 38 on the anode side of the fuel cell 12 is open, so that hydrogen can be supplied from the hydrogen source 40 to the anode area 14 via the anode gas supply line 36. The second and the fourth valve 46, 54 are closed. In contrast, the third valve 52 is open, so that anode exhaust gases issuing from the outlet 42 of the anode area 14 can be recirculated via the recirculation line 48 by means of the additional pump 50.

To reduce corrosion of the carbon material serving as cathode catalyst layer, the anode loop is purged with air after the shutdown of the fuel cell system 10, i.e., after the disconnecting of an electrical connection (not shown) between the fuel cell 12 and a load (not shown either) driven by the fuel cell 12. For this, one first interrupts the hydrogen supply into the anode area 14 by closing the first valve 38. Subsequently, one closes the third valve 52, whereas the second and the fourth valve 54 <sic> are opened. As a result, the additional pump 50 can draw in ambient air from the purge air line 56 into the recirculation line 48, which then can be supplied to the anode area 14. The purge air is discharged from the anode area 14 via the open second valve 46.

The pump 50 delivers the purge air to the anode area 14 at a high flow rate, so that the anode area 14 is completely filled with air within a very short time span of approximately one second. Purging the anode loop with air significantly shortens the time period during which the cathode area 18 of the fuel cell 12 is filled by air and different sections of the anode area 14 at the same time contain air and residual hydrogen. Because of this, corrosion of the cathode catalyst carrier is effectively reduced.

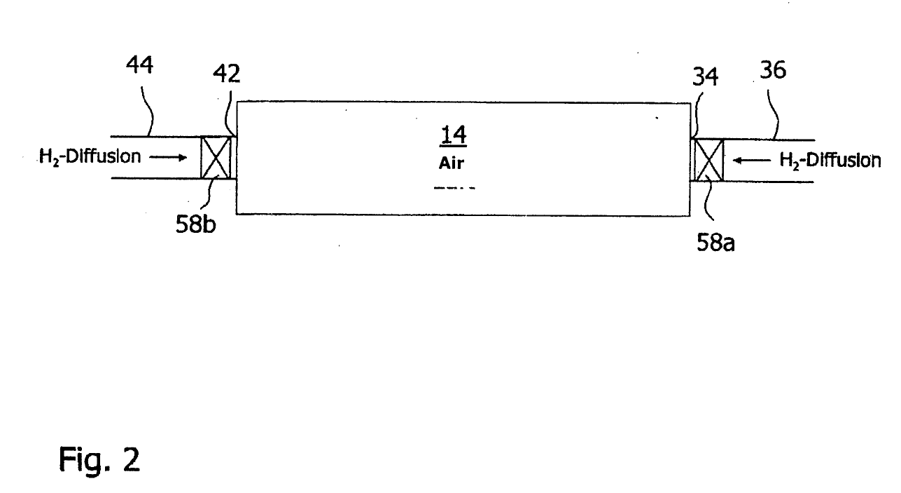

The mode of functioning of the additional catalysts 58a, 58b will now be explained in more detail with the help of FIG. 2. Since even after the purge of the anode loop with air there are still traces of residual hydrogen present in the components 36, 38, 44, 46, 48, 50, 52, 54, 56 of the anode loop, hydrogen molecules will diffuse through the anode gas supply line 36 and the anode gas discharge line 44 in the direction towards the anode area 14 during the downtime of the fuel cell system 10 after the purge process. To prevent ingress of these hydrogen molecules into the air-filled anode area 14 and the associated formation of inhomogeneities in the gas composition in the anode area 14, additional catalysts 58a, 58b are arranged in a section of the anode gas supply line 36 adjacent to the inlet 34 of the anode area 14 and in a section of the anode gas discharge line 44 adjacent to the outlet 42 of the anode area 14.

Both of the additional catalysts 58a, 58b are platinum catalysts that have been applied to a catalyst carrier material that is developed as a mesh. Any hydrogen diffusing in the direction towards the anode area 14 reacts at the additional catalysts 58a, 58b with the air oxygen present in the anode loop to form water, so that any ingress of hydrogen into the air-filled anode area 14 is safely prevented. In this manner one reliably prevents the formation of inhomogeneities in the gas composition in the anode area 14 and the resulting corrosion of the cathode catalyst carrier even during the downtime of the fuel cell system 10.

In a further embodiment (not shown) of the fuel cell system 10, the additional catalysts 58a, 58b in the anode area 14 are arranged immediately at the inlet 34 and the outlet 42 of the anode area 14.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A fuel cell system having at least one fuel cell that comprises an anode area and a cathode area that is separated from the anode area by an electrolyte, whereby the anode area and the cathode area each contain a catalyst for catalytic conversion of reactants being supplied to the fuel cell, and wherein the anode area contains air or oxygen during the downtime of the fuel cell, the fuel cell system comprising an additional catalyst provided in the region of an inlet and/or in the region of an outlet of the anode area, wherein the additional catalyst catalytically converts hydrogen diffusing towards the anode area during the downtime of the fuel cell when the anode area contains air or oxygen.

2. The fuel cell system of claim 1 wherein the additional catalyst is arranged in the anode area only, and directly at the inlet and/or at the outlet of the anode area.

3. The fuel cell system of claim 1 wherein the additional catalyst is arranged in a section of a fluid supply line adjacent to the inlet of the anode area, in a section of a fluid discharge line adjacent to the outlet of the anode area, or both.

4. The fuel cell system of claim 1 wherein the additional catalyst is a platinum catalyst.

5. The fuel cell system of claim 1 wherein the additional catalyst is a catalytic coating applied onto an inlet section and/or outlet section of the anode area, or onto an interior surface of a fluid supply line connected to the inlet of the anode area and/or of a fluid discharge line connected to the outlet of the anode area.

6. The fuel cell system of claim 1 wherein the additional catalyst is applied onto a carrier.

7. The fuel cell system of claim 6 wherein the catalyst carrier is a mesh, a non-woven fabric, or monolithically.

8. The fuel cell system of claim 1 wherein the fuel cell system comprises means for purging the anode area with air.

9. The fuel cell system of claim 8 wherein the fuel cell system comprises an anode loop with an anode gas recirculation line.

10. The fuel cell system of claim 9 wherein the means for purging the anode area with air purges with air all components of the anode loop that have a fluid-conducting connection to the anode area of the fuel cell.

11. A method to shut down a fuel cell system having at least one fuel cell that has an anode area and a cathode area that is separated from the anode area by an electrolyte, and wherein the anode area and the cathode area each contain a catalyst for the catalytic conversion of reactants being supplied to the fuel cell, the method comprising the following steps:
interrupting an electrical connection between the fuel cell and a load;
interrupting the supply of hydrogen into the anode area of the fuel cell;
filling the anode area of the fuel cell with air or oxygen; and
catalytically converting hydrogen, which, during the downtime of the fuel cell, diffuses towards the air-filled or oxygen-filled anode area with an additional catalyst that is arranged in a region of an inlet and/or in the region of an outlet of the anode area.

12. The method of claim 11 wherein the anode area of the fuel cell is purged with air after the interruption of the electrical connection between the fuel cell and the load, and after the interruption of the supply of hydrogen into the anode area.

13. The method of claim 12 wherein all components of an anode loop that have a fluid-conducting connection to the anode area of the fuel cell are purged with air after the interruption of the electrical connection between the fuel cell and the load, and after the interruption of the supply of hydrogen into the anode area.

14. The fuel cell of claim 1 wherein the fuel cell system comprises an anode loop with an anode recirculation line.
